(19) United States
(12) Patent Application Publication
(10) Pub. No.: US 2024/0413707 A1
(43) Pub. Date: Dec. 12, 2024

(54) ULTRA A/C AND D/C ELECTRICAL RE-GENERATION DEVICE

(71) Applicant: EDDIE LEE BROOKS, TYLERTOWN, MS (US)

(72) Inventor: EDDIE LEE BROOKS, TYLERTOWN, MS (US)

(21) Appl. No.: 18/741,691

(22) Filed: Jun. 12, 2024

Related U.S. Application Data
(60) Provisional application No. 63/472,393, filed on Jun. 12, 2023.

(51) Int. Cl. H02K 7/18

(52) U.S. Cl. CPC H02K 7/1815

(57) ABSTRACT

An A/C and D/C electrical re-charging device includes a first and second generator in communication with an electric motor. The first generator is configured to generate electrical power and selectively distribute the electrical power to the electric motor and the second generator. The first and second generators are in mechanical connection with each other and are selectively engaged with the electric motor via a clutch. Electrical power is produced from the first generator and the second generator. Electrical power may be exchanged between the first generator and the electric motor via wired connection. Output power from the device may be produced from any combination of the first and second generators and the electric motor.

### CROSS REFERENCE TO RELATED APPLICATIONS

This application claims the benefit of an earlier filing date and right of priority to U.S. Provisional Application No. 63/472,393, filed 12 Jun. 2023, the contents of which is incorporated by reference herein in its entirety.

### BACKGROUND OF THE INVENTION

### 1. Field of the Invention

The present application relates to power generation, and more particularly to a combined device generating different power through multiple generators and an electric motor.

### 2. Description of Related Art

Power generation is an important part of society. Concerns have existed for decades about the ability of society to generate power and to do so efficiently. In recent times, steps have been taken to make power generation more efficient. As the world has electrified, devices such as generators have been developed to convert a fuel source into an electrical power generator. Electric motors are utilized to produce work from electrical energy. Alone, both generators and motors have a use and are restricted to particular constraints related to power production and use. Systems typically have failed to harness the combined effects and benefits through integrating generators and electric motors to enhance efficiency.

Although strides have been made, shortcomings remain. It is desired that an assembly be provided that combines a plurality of generators with an electric motor to create a singular unit configured to produce both A/C and/or D/C electrical energy.

### BRIEF SUMMARY OF THE INVENTION

An object of the device of the present application is related to producing A/C and or D/C Electrical Power on multiple platforms and in multiple phases of electrical voltage, such as single phase-six phases of voltage providing single phase-3 phases as portable units, and single phase-six phases as industrial units being portable or stationary units. In respect to the above benefits the value rises to electrical power enhancements of new and reusable energy on multiple levels on land, on water and in the air etc.

The Ultra A/C and/or D/C Electrical Re-Generation Device is manufactured to provide highly efficient power generation. Novel benefits are realized from the present device when it is used for electrical power generation from single phase through six phases of voltage. It is also capable of producing useable and reusable electrical power on land, on water and in the air. The device of the present application is capable of providing and using both A/C electrical power and D/C electrical power. The device includes two or more very powerful generators coupled together and operative in combination with an electric motor. The device incorporates electrical controllers and converters. The device is configured as a very evolved and unique drive system configured to optimize torque and speed when applied within or onto industrial applications within transportation vehicle and other power systems, or even alternatively as a common portable home use system. This device is operable for extended periods of time (i.e. weeks or months) and provides maximum fuel economy.

It is an object of the present device to provide an efficient backup or standby power generation system for solar systems and to increase productivity in electrical power. The combined device may be used with stationary devices or portable products and machines.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a top view of an electrical re-generation device according to an embodiment of the present application.

FIG. 2 is an exemplary front view of the device of FIG. 1.

FIG. 3 is an expanded top view of the device of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the electrical regeneration device of the present application is configured to functionally correlate and couple the operation of a plurality of generators with that of a single electric motor. The system or device is capable of running off either alternating current or direct current and is also configured to produce electronic voltage dispersed through a control panel. Individual generators and or electric motors within the device are selectively linked so as to feed to or from each other so as to independently link the electric motor with a generator for operation. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

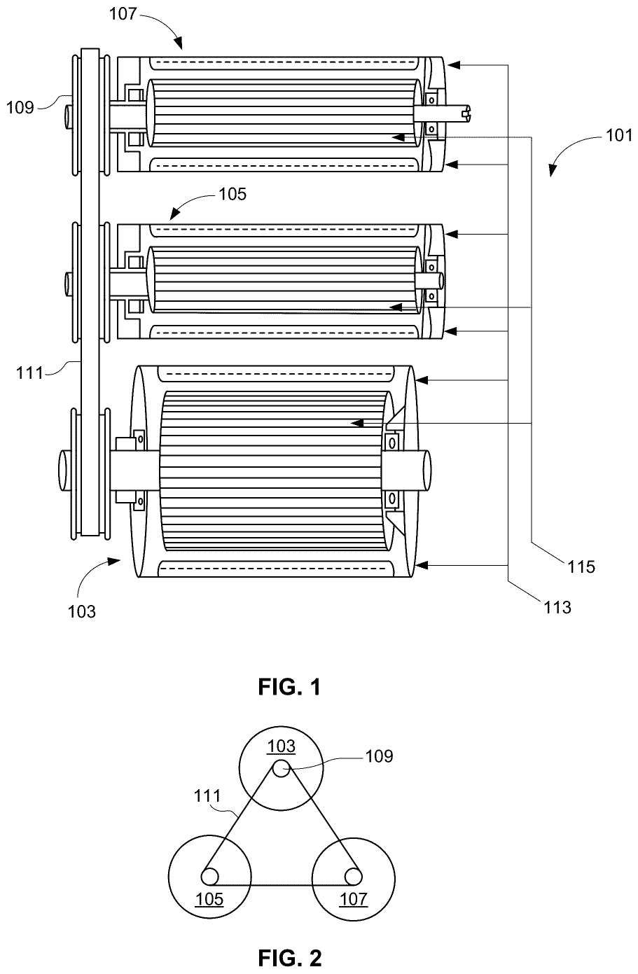

Referring now to FIGS. 1-2 in the drawings, a top view and front view of the AC and DC electrical regeneration device 101 is illustrated. The top view is seen in FIG. 1 and illustrates a combined operative system wherein multiple generators 105 and 107 are linked to a singular electric motor 103. Device 101 utilizes a plurality of pulleys or gears 109 in combination with one or more belts or chains 111 to synchronize their operation. Field coils 113 are located within each of motor 103 and generators 105 and 107. Additionally, armatures 115 are shown to provide amazing efficiencies and longevity. It is understood that any units, consisting of motor 103 and generators 105 and 107, may be used to drive operation of the other units. It is also understood that the device of the present application is not limited herein to pulleys 109 and belts 111 but maybe interconnected via any known connection methods.

As seen with FIG. 2, front view of device 101 is illustrated. FIG. 2 is meant to be an exemplary view illustrating a potential alignment and orientation of each of the units. Electric motor 103 and generators 105 and 107 may be situated or aligned in a nestled configuration to permit optimal use of belt 111 and pulleys 109. Device 101 is illustrated in a triangular shape but such shape is not here in limiting. It is to be understood that motor 103 may be connected to generator 105 and generator 107 individually such that generator 105 and generator 107 do not directly connect to each other. In this manner the illustrated alignment in FIG. 2 is exemplary in nature.

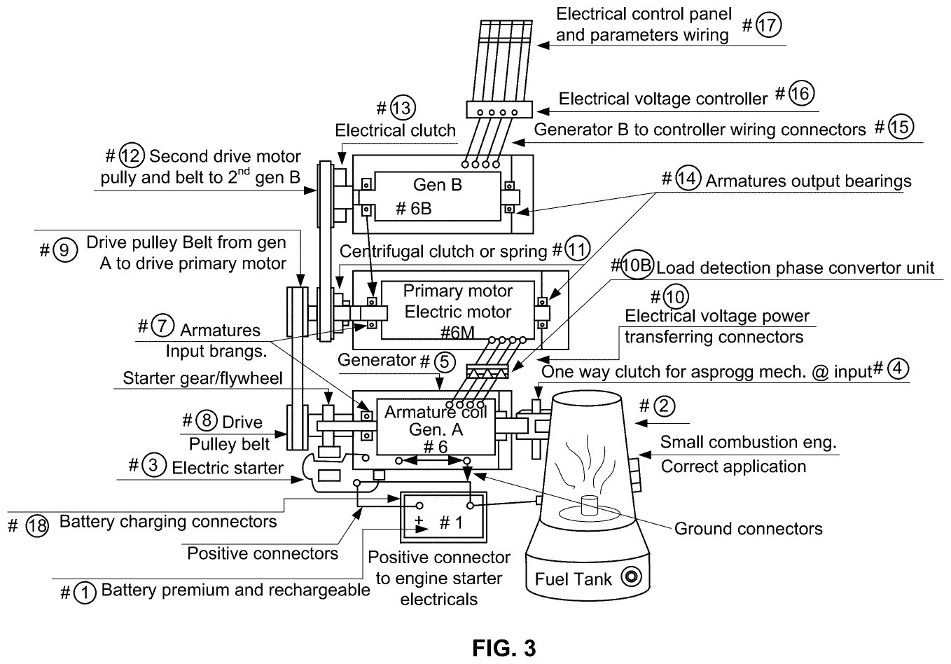

Referring now also to FIG. 3 in the drawings, an exemplary detailed top view of device 101 is illustrated. It is noted that the individual call outs and names of individual parts within device 101 are provided in FIG. 3 and are not solely provided herein within the description. Device 101 may include electric motor 6M which is similar in form and function to that of electric motor 103 from FIG. 1. Additionally, generator 6A and 6B are similar in form and function to that of generators 105 and 107 respectively. In this illustrated embodiment generator 6 communicates with electric motors 6M via a belt and pulley mechanism 8 while electric motor 6M also communicates directly with generator 6B. In this configuration generator 6 does not directly communicate with generator 6B independent from electric motor 6M. It is understood that electric motor 6M utilizes a centrifugal clutch 11 which may operatively disengage electric motor 6M from drive pulley 9 thereby effectively creating a direct link between generator 6 and generator 6B.

Device 101 may further include a fuel tank with corresponding small combustion engine 2. Additionally included may also be a battery 1. The battery and small combustion engine may be used to start generator 6. Battery one is wired to facilitate operation of small combustion engine two as well as starter 3 which communicates with drive belt pulley 8 from generator 6. Starter 3 is configured to selectively start generator 6. In this way generator 6 may be started via battery one through starter 3 or through powering small combustion engine 2. A clutch 4 maybe located between small combustion engine two and generator 6.

Upon starting of generator 6, an electrical charge is generated as well as rotation of drive belt and pulley 8. Electrical charge generated from generator 6 may be supplied through electrical voltage power transferring connections 10 and a corresponding load detection phase converter unit 10B. Power may be exchanged between motor 6M and generator 6 in both directions such that electrical power generated from either unit may be supplied to the other. It should also be noted that power generated from generator 6 may be rerouted through electrical connections 18 so as to charge or recharge battery 1.

Drive belt and pulley 8 connects generators 6 to electric motor 6M at drive belt and pulley 9. The pulley system operative with electric motor 6M is also coupled via a secondary pulley and drive belt system 12 that links generator 6B to that of electric motor 6M. Generator 6 may utilize pulley systems 8 and 9 to generate power within electric motor 6M by rotating a centralized shaft. As noted previously, power may also be provided to electric motor 6M via connections 10 to allow for electric power to be transferred bidirectionally between them.

It is understood that device 101 may utilize any number of units consisting of generator 6, generator 6B, and electric motor 6M to provide electrical power through connectors 15 via controller 16 hand panel 17. In operation generator 6 may provide electrical power to operate electric motor 6M or may receive electrical power from electric motor 6M through connection 10. Electric power maybe delivered to control panel 17 from generator 6B alone or a combination of generator 6B with that of generator 6 and/or electric motor 6M.

It is understood that clutch 11 may selectively engage and disengage electric motor 6M depending on the operation of device 101 as a whole. In some embodiments it is conceived that generator 6 may provide power to electric motor 6M through pulley 9 wherein clutch 11 is engaged all while Electric motor 6 M is providing electrical power to enhance or add to that of generator 6 via connectors ten. A key feature of device 101 is the ability for different types of generators and electric motors to work together within their efficient ranges to provide a seamless power generation. A further object is that each of the units within device 101 are interrelated and operative in various different combinations depending on environmental conditions.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An electric re-charging device, comprising:
a first generator configured to generate electrical power;
an electric motor in communication with the first generator, the electric motor electrically coupled to the first generator through power connectors to permit the passage of electrical power bidirectionally between the electric motor and the first generator, the electric motor also mechanically coupled to the electric motor to permit the generator to produce electrical power in the electric motor; and
a second generator configured to generate electrical power, the second generator in communication with the electric motor and the first generator, the second generator configured to generate electrical power, the second generator being mechanically coupled to the electric motor and the first generator, wherein the electric motor includes a clutch to selectively mechanically engage and disengage the electric motor from the first generator and the second generator;
where in electrical output power is generated through the interaction of any combination of the first generator, the electric motor, and the second generator.

2. The device of claim 1, further comprising:
a battery in electrical connection with the first generator and configured to provide electrical power to the first generator to start the first generator.

3. The device of claim 2, further comprising:
a small combustion engine coupled to the battery, the small combustion engine mechanically coupled to the first generator and being configured to start the first generator from electrical power received from the battery.

4. The device of claim 2, wherein the battery is configured to be recharged by the reception of electrical power from the first generator.

5. The device of claim 1, further comprising:
a battery and a small combustion engine, the battery configured to supply power to the small combustion engine, the small combustion engine configured to selectively start the first generator.

6. The device of claim 1, wherein the first generator and the second generator are mechanically coupled independent from the electric motor.

7. The device of claim 1, wherein the first generator is mechanically coupled to the electric motor and the electric motor electrically transfers electrical power to the first generator through power connectors.

8. The device of claim 1, wherein the first generator, the second generator, and the electric motor may generate or use either alternating current or direct current.

9. The device of claim 1, wherein the output power from generator B may be used to power stationary devices or portable products or machines.
